(19) United States
(12) Patent Application Publication
(10) Pub. No.: US 2005/0265692 A1
(43) Pub. Date: Dec. 1, 2005

(54) Apparatus, method, and program for image reproduction

(75) Inventors: Toshihiko Kaku, Kanagawa-ken (JP); Fumihiro Sonoda, Kanagawa-ken (JP); Kazuki Nakajima, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/139,572

(22) Filed: May 31, 2005

(30) Foreign Application Priority Data
May 28, 2004 (JP) 159650/2004

(51) Int. Cl. H04N 5/76; H04N 5/781

(52) U.S. Cl. 386/46; 386/125

(57) ABSTRACT

Upon resumption of a slide show of image data sets with reference to a playlist, the slide show can be resumed from where the slide show has been suspended. For this purpose, the slide show is reproduced as serial reproduction of the image data sets with reference to the playlist. Upon suspension of the slide show, where the slide show has been suspended is set as a restart point in the playlist. The slide show is resumed from the restart point with reference to the restart point set in the playlist.

### BACKGROUND OF THE INVENTION

1. Field of the Invention

The present invention relates to an image reproduction apparatus and an image reproduction method for reproducing a slide show by serially reproducing image data sets. The present invention also relates to a program for causing a computer to execute the image reproduction method.

2. Description of the Related Art

A method has been proposed for reproducing on a reproduction apparatus, such as a personal computer, a slide show of image data sets, obtained by a digital camera or by reading images from a negative film or prints with a scanner or the like.

For example, a method of reproducing image data sets in reproduction order defined by a reproduction sequence table has been proposed in Japanese Unexamined Patent Publication No. 2001-103415.

Furthermore, a method of reproducing audio data sets in a preset reproduction order at the same time of reproduction of image data sets related to the audio data sets has been proposed in Japanese Unexamined Patent Publication No. 2003-303488.

When image data sets are reproduced by the above-described reproduction apparatus or the like, an effect may be added thereto. For example, a method has been proposed for reproducing an image by rotating, enlarging, or reducing the image, or overlapping with one or more images. A method has also been proposed for reproducing images with a wipe effect or at various image changing speeds.

In addition, a method has also been proposed for reproducing image data sets in the form of a slide show with reference to a playlist that defines a manner of reproduction of such effects, reproduction order of the image data sets, and audio data sets to be played together with the image data sets.

Meanwhile, a moving image reproduction system has also been proposed in Japanese Unexamined Patent Publication No. 9(1997)-214873, for storing where reproduction of a moving image has been suspended, and for reproducing the moving image therefrom at the time of resumption of the reproduction.

In the case where a slide show is reproduced with reference to a playlist as has been described above, reproduction of the slide show may be paused in some cases. In the case of reproduction of a moving image, the reproduction can be resumed from where the reproduction has been suspended, according to the method described in Japanese Unexamined Patent Publication No. 9(1997)-214873. Furthermore, where the reproduction has been suspended can be found by fast forward of the moving image. However, in the case where a slide show is reproduced according to a playlist, the slide show cannot be reproduced from where the slide show has been suspended. In addition, fast forward of the slide show cannot be carried out. Therefore, a part of the slide show that has been viewed once needs to be shown again from the beginning thereof to where the slide show has been suspended.

### SUMMARY OF THE INVENTION

The present invention has been conceived based on consideration of the above circumstances. An object of the present invention is therefore to enable resumption of a slide show of image data sets from where the slide show has been suspended, with reference to a playlist.

An image reproduction apparatus of the present invention comprises:
slide show reproduction means for reproducing a slide show by serial reproduction of image data sets with reference to a playlist that defines a manner of the serial reproduction;
restart point setting means for setting a restart point in the playlist for resuming the slide show after suspension thereof; and
slide show restarting means for resuming the slide show from the restart point with reference to the playlist, in response to an instruction to resume the slide show.

The restart point may be set on an image that was being displayed at the time of suspension of the slide show. Alternatively, the restart point may be set on an image arranged one to several frames backward from the image that was being displayed at the time of suspension. In the case where the slide show has chapters, generated by dividing the image data sets into a predetermined number of images (such as 10 images), the restart point may be set on the chapter including the image that was being displayed at the time of suspension so that the chapter is reproduced from the beginning thereof upon resumption of the slide show.

The image reproduction apparatus of the present invention may further comprise rewritable recording means for recording the playlist so that the restart point setting means can set the restart point in the playlist recorded in the rewritable recording means.

In this case, the image reproduction apparatus may further comprise playlist deletion means for deleting the playlist recorded in the rewritable recording means after the slide show has been completely reproduced.

In the case where the playlist is recorded in external recording means, the restart point setting means in the image reproduction apparatus of the present invention may set the restart point in the playlist recorded in the external recording means.

In the case where the image data sets and the playlist are recorded in a rewritable recording medium, the restart point setting means of the image reproduction apparatus of the present invention may set the restart point in the playlist recorded in the rewritable recording medium.

An image reproduction method of the present invention comprises the steps of:
reproducing a slide show by serial reproduction of image data sets with reference to a playlist that defines a manner of the serial reproduction;
setting a restart point in the playlist for resuming the slide show after suspension thereof; and
resuming the slide show from the restart point with reference to the playlist, in response to an instruction to resume the slide show.

The image reproduction method of the present invention may be provided as a program for causing a computer to execute the image reproduction method.

According to the present invention, the restart point is set in the playlist for resumption of the slide show after suspension thereof, and the slide show is resumed from the restart point with reference to the playlist in response to the instruction to resume the slide show. Therefore, the slide show is not reproduced from the beginning thereof after suspension thereof, and a viewer does not need to view the same images that have been reproduced once in the slide show.

By recording a playlist in the rewritable recording means and by setting the restart point in the playlist, each of slide shows can have the playlist stored therein for resumption thereof from the restart point.

In this case, by deleting the playlist after reproduction of a corresponding one of the slide shows has been completed, imitation thereof can be prevented in the case where the manner of reproduction defined by the playlist is copyrighted, which is preferable.

By recording the playlist in the external recording means, the slide show can be resumed from the restart point with reference to the playlist recorded in the external recording means even in the case where the slide show is viewed in different places such as a living room and a bedroom before and after the suspension thereof.

In the case where the image data sets and the playlist are recorded in the rewritable recording medium, the slide show can be resumed from the restart point with use of another reproduction apparatus, by setting the restart point in the playlist in the recording medium.

Note that the program of the present invention may be provided being recorded on a computer readable medium. Those who are skilled in the art would know that computer readable media are not limited to any specific type of device, and include, but are not limited to: CD's, RAM's ROM's, hard disks, magnetic tapes, and internet downloads, in which computer instructions can be stored and/or transmitted. Transmission of the computer instructions through a network or through wireless transmission means is also within the scope of this invention. Additionally, the computer instructions include, but are not limited to: source, object, and executable code, and can be in any language, including higher level languages, assembly language, and machine language.

### BRIEF DESCRIPTION OF THE DRAWINGS

FIG. 1 is a block diagram showing the configuration of an HDD recorder adopting an image reproduction apparatus of the present invention;

FIG. 2 shows a playlist;

FIG. 3 shows an example of the playlist in which a restart point has been set;

FIG. 4 shows another example of the playlist in which the restart point has been set;

FIG. 5 shows a table relating media IDs and playlists;

FIG. 6 shows a manner for recording the playlist in a server connected to a network; and

FIG. 7 shows still another example of the playlist in which restart points have been set.

### DESCRIPTION OF THE PREFERRED EMBODIMENT

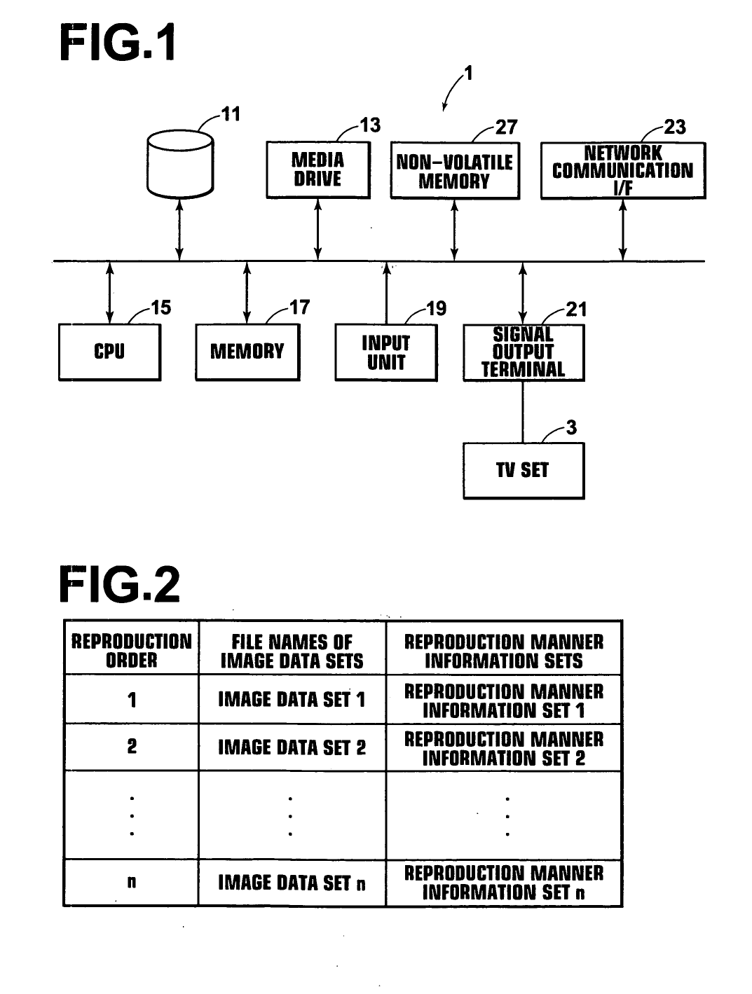

Hereinafter, an embodiment of the present invention will be described with reference to the accompanying drawings. FIG. 1 is a block diagram showing the configuration of an HDD recorder adopting an image reproduction apparatus of the present invention. As shown in FIG. 1, an HDD recorder 1 in this embodiment comprises a RAID 11, a media drive 13, a CPU 15, a memory 17, and an input unit 19. The RAID 11 comprises a plurality of HDDs (2 HDDs in this embodiment) for storing image data sets and moving image data sets that have been recorded. The media drive 13 records the image data sets and the moving image data sets in a recordable recording medium such as a DVD-R, and reads image data sets and moving image data sets recorded in a recording medium. The CPU 15 controls the entire HDD recorder 1, and carries out various kinds of control such as recording control regarding the image data sets and the moving image data sets, communication control, reproduction control for reproducing a slide show of image data sets recorded in a recording medium, and display control. The memory 17 comprises an area that stores various constants and software such as a slide show reproduction program and an operation program for the CPU 15, and a workspace used by the CPU 15. The input unit 19 is used by a user for inputting various kinds of instructions to the HDD recorder 1.

The HDD recorder 1 also has a signal output terminal 21 for outputting an audio signal and a video signal to a TV set 3, and a network communication interface 23 connected to a network.

The HDD recorder 1 also has a non-volatile memory 27 that can store various kinds of information even after the HDD recorder 1 is turned off.

By executing the slide show reproduction program, the CPU 15 serves as the slide show reproduction means, the restart point setting means, the slide show restarting means, and the playlist deletion means.

In this embodiment, the slide show in which the image data sets recorded in the recording medium are displayed serially can be reproduced on the TV set 3 by starting the slide show reproduction program. More specifically, the slide show is reproduced with reference to a playlist stored in the recording medium together with the image data sets for defining a manner of reproduction of the image data sets.

The playlist defines the manner of reproduction of the image data sets, as has been described above. More specifically, as shown in FIG. 2, the playlist is represented as data describing a list of reproduction order of image data sets 1 to n, file names of the image data sets, and reproduction manner information sets 1 to n for the image data sets 1 to n. The playlist is interpreted by the slide show reproduction program run by the CPU 15, and a control signal is output to the TV set 3 in such a manner that the image data sets are reproduced in the manner defined by the reproduction manner information sets in the reproduction order defined in the playlist.

The reproduction manner information sets for the image data sets include information on resolution, a manner of image change, and an effect for the corresponding image data sets. However, as long as the reproduction manner information sets can define a method of reproducing the image data sets as visible images, the reproduction manner information sets can be any information. The information on the manner of image change may include information on a speed of image change and an effect of image change such as wipe. However, any information regarding a manner of image change can be used therefor. The information on effect refers to information on generating a composite image, image rotation, image enlargement, image reduction, and layers of images, for example. However, any image editing information can be used therefor.

In this embodiment, the playlist recorded in the recording medium is copied in the non-volatile memory 27 at the time of reproduction of the slide show. With reference to the copied playlist, the slide show is reproduced.

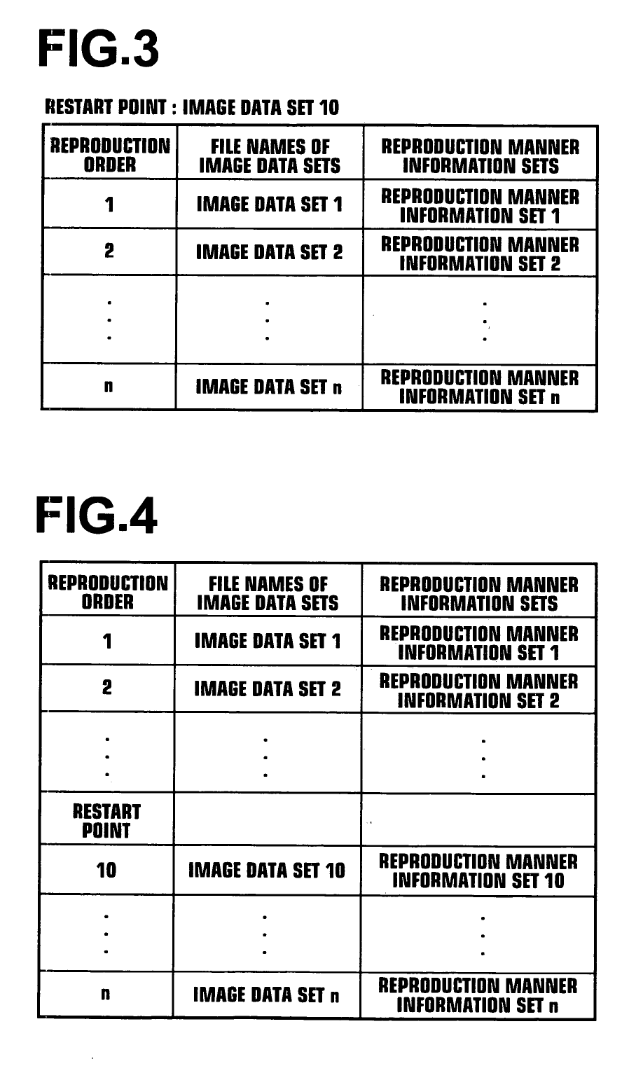

The user may suspend reproduction of the slide show in some cases. In this embodiment, the HDD recorder 1 sets where the slide show has been suspended as a restart point in the playlist recorded in the non-volatile memory 27, at the time of suspension of the slide show. FIG. 3 shows the playlist in which the restart point has been set. As shown in FIG. 3, the restart point is set by a description of “Restart Point: Image Data Set 10” at the top of the playlist. This description refers to resumption of the slide show from the image data set 10, since the slide show has been suspended at the time of reproduction of the image data set 10. As shown in FIG. 4, the slide show can also be resumed from the image data set 10 by a description of a “Restart Point”, set before the image data set 10 in the playlist.

The restart point may be set on the image data set listed one to several frames backward from the image data set that was being reproduced at the time of suspension of the slide show. For example, in the case where the image data set 10 was being displayed at the time of suspension of the slide show, the restart point may be set in such a manner that the slide show can be resumed from the image data set 8 or 9.

In the case where chapters have been set in the slide show by dividing the slide show into images of a predetermined number (such as 10 images), the restart point may be set in such a manner that the chapter including the image being displayed at the time of suspension can be reproduced from the beginning thereof upon resumption of the slide show.

In the case where the slide show has been suspended with a description of the restart point in the playlist for setting the restart point, the slide show can be resumed from the restart point set in the playlist in response to an instruction input to the HDD recorder 1 after the recording medium is set in the media drive 13. Therefore, the slide show is not reproduced from the beginning thereof after the slide show has been suspended. As a result, the user does not need to repeatedly view the images that have been reproduced once in the slide show.

After completion of reproduction of the slide show, the CPU 15 deletes the playlist from the non-volatile memory 27. In this manner, the manner of reproduction defined by the playlist can be prevented from being imitated especially in the case where the manner is copyrighted, which is preferable.

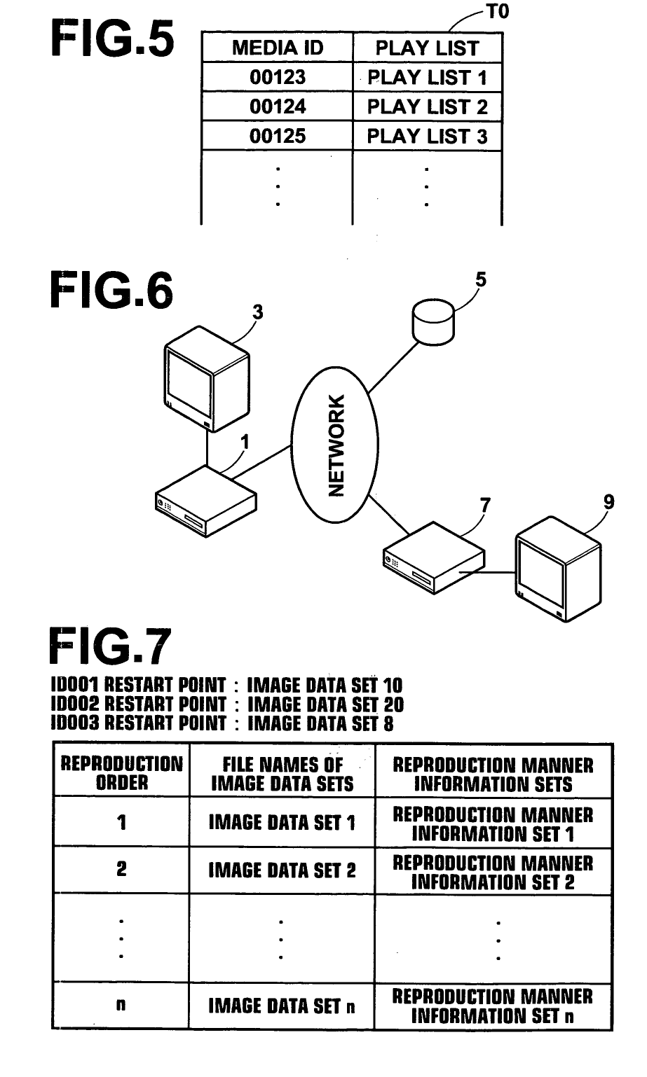

Since recording media respectively have media IDs, it is preferable for playlists of slide shows to be stored in the non-volatile memory 27 in relation to the media IDs. FIG. 5 shows a table relating the playlists and the media IDs. As shown in FIG. 5, a table T0 describes the playlists related to the media IDs.

In this case, when one of the recording media is set in the media drive 13, the CPU 15 reads the media ID of the recording medium. By judging whether the table T0 includes the media ID, the CPU 15 judges whether a slide show of image data sets recorded in the recording medium has been reproduced by the HDD recorder 1 in this embodiment. In the case where the table T0 includes the media ID, the CPU 15 resumes the slide show from the restart point set in the playlist corresponding to the media ID. In the case where the table T0 does not include the media ID, the CPU 15 stores the playlist recorded in the recording medium in the non-volatile memory 27, and reproduces the slide show of the image data sets recorded in the recording medium from the beginning thereof with reference to the playlist.

The playlist may be added with the ID thereof. In this case, the ID of the playlist stored in the non-volatile memory 27 is compared with the ID of the playlist stored in the recording medium set in the media drive 13. In this manner, judgment can be made as to whether the slide show of the image data sets recorded in the recording medium has been reproduced by the HDD recorder 1.

In the case where the recording medium is rewritable, the playlist in the recording medium may have been rewritten by change of the reproduction order or the reproduction manner of the image data sets. Consequently, the content of the playlist in the recording medium does not agree with the content of the playlist stored in the non-volatile memory 27 regardless of agreement of the media IDs and the playlist IDs therein. In this case, the playlist in the recording medium is stored in the non-volatile memory 27 so that the slide show can be reproduced from the beginning thereof with reference to the new playlist.

The playlist in the non-volatile memory 27 may be compared with the playlist in the recording medium. In the case where the reproduction order and the reproduction manner in the playlist in the non-volatile memory 27 are the same as in the playlist in the recording medium to the restart point set in the playlist in the non-volatile memory 27, the slide show may be resumed from the restart point set in the playlist recorded in the non-volatile memory 27, with reference to the playlist recorded in the recording medium.

In the embodiment described above, the playlist is stored in the non-volatile memory 27. However, in the case where the recording medium is rewritable, the restart point may be set by being described in the playlist in the recording medium. In this manner, even in the case where the slide show is reproduced by another reproduction apparatus, the slide show can be resumed from the restart point.

In the embodiment described above, the playlist is stored in the non-volatile memory 27. However, as shown in FIG. 6, the playlist may be stored in a server 5 connected to the HDD recorder 1 via a network. By storing the playlist in the server 5, in the case where the HDD recorder 1 and the TV set 3 are placed in a living room while another HDD recorder 7 and another TV set 9 are placed in a bedroom, the restart point is set in the playlist stored in the server 5 when the slide show is suspended during reproduction thereof by the HDD recorder 1 in the living room with reference to the playlist in the server 5. By moving the recording medium from the HDD recorder 1 to the HDD recorder 7, the user can resume the slide show in the bedroom with reference to the playlist stored in the server 5.

In the embodiment described above, the restart point may be set differently for each of viewers. For example, in the case where the HDD recorder 1 is used by a father, a mother, and a son, each of the viewers has the ID thereof (such as 001, 002 and 003 for the father, the mother, and the son, respectively). The ID is input to the HDD recorder 1 upon reproduction of the slide show. In the case where the slide show has been suspended, the restart point is described and set in the playlist by being related to the ID, as shown in FIG. 7. In this manner, the restart point can be set for each of the viewers.

1. An image reproduction apparatus comprising:
slide show reproduction means for reproducing a slide show by serial reproduction of image data sets with reference to a playlist defining a manner of the serial reproduction;
restart point setting means for setting a restart point in the playlist for resuming the slide show after suspension thereof; and
slide show restarting means for resuming the slide show from the restart point with reference to the playlist, in response to an instruction to resume the slide show.

2. The image reproduction apparatus according to claim 1 further comprising rewritable recording means for recording the playlist, wherein
the restart point setting means sets the restart point in the playlist recorded in the rewritable recording means.

3. The image reproduction apparatus according to claim 2 further comprising playlist deletion means for deleting the playlist recorded in the rewritable recording means after the slide show has been completely reproduced.

4. The image reproduction apparatus according to claim 1, wherein, in the case where the playlist is recorded in external recording means, the restart point setting means sets the restart point in the playlist recorded in the external recording means.

5. The image reproduction apparatus according to claim 1, wherein, in the case where the image data sets and the playlist are recorded in a rewritable recording medium, the restart point setting means sets the restart point in the playlist recorded in the rewritable recording medium.

6. The image reproduction apparatus according to claim 1, wherein the restart point is on an image that was being displayed at the time of suspension of the slide show.

7. The image reproduction apparatus according to claim 1, wherein the restart point is on an image arranged one to several frames backward from an image that was being displayed at the time of suspension of the slide show.

8. The image reproduction apparatus according to claim 1, wherein, in the case where the slide show has chapters, the restart point is on the first image of the chapter including an image that was being displayed at the time of suspension of the slide show.

9. An image reproduction method comprising the steps of:
reproducing a slide show by serial reproduction of image data sets with reference to a playlist defining a manner of the serial reproduction;
setting a restart point in the playlist for resuming the slide show after suspension thereof; and
resuming the slide show from the restart point with reference to the playlist, in response to an instruction to resume the slide show.

10. A program for causing a computer to execute an image reproduction method comprising the steps of:
reproducing a slide show by serial reproduction of image data sets with reference to a playlist defining a manner of the serial reproduction;
setting a restart point in the playlist for resuming the slide show after suspension thereof; and
resuming the slide show from the restart point with reference to the playlist, in response to an instruction to resume the slide show.

11. A computer readable medium, having the program defined in claim 10 recorded therein.
